(19) United States
(12) Patent Application Publication
(10) Pub. No.: US 2015/0158191 A1
(43) Pub. Date: Jun. 11, 2015

(54) RAZOR CARTRIDGE HAVING COMB GUARD

(71) Applicant: DORCO CO., LTD., Seoul (KR)

(72) Inventors: Hyo gyun Jeong, Seoul (KR); Da woon Han, Seoul (KR); Jun su Jang, Seoul (KR)

(73) Assignee: DORCO CO., LTD., Seoul (KR)

(21) Appl. No.: 14/406,635

(22) PCT Filed: Jun. 12, 2013
(86) PCT No.: PCT/KR2013/005198

§ 371 Date: Dec. 9, 2014

(30) Foreign Application Priority Data
Jun. 13, 2012 (KR) 10-2012-0062995

(51) Int. Cl. B26B 21/40; B26B 21/44; B26B 21/22

(52) U.S. Cl. CPC B26B 21/4018; B26B 21/222; B26B 21/443

(57) ABSTRACT

A razor cartridge that includes: a frame for forming the exterior; a comb guard protruding from a front end of the frame, to align the hair during shaving; a first blade which is coupled to a first slot formed in the front end of the frame, and which is arranged adjacent to the rear portion of the comb guard, to cut the hair aligned by the comb guard; at least one second blade which is coupled to a second slot formed in the rear end of the cartridge frame, which further cuts the hair cut by the first blade. Accordingly, the hair aligned by the comb guard is firstly cut by a single blade, i.e. the first blade, and then the firstly cut hair is further cut by multiple blades, i.e. the second blades, thus performing shaving in a reliable manner regardless of the length or thickness of the hair.

### TECHNICAL FIELD

The present invention relates to a razor cartridge, and more particularly to a razor cartridge capable of reliably shaving regardless of the length of hair by firstly cutting with a first blade the hair aligned by a comb guard, and further cutting with the second blades the firstly cut hair.

### BACKGROUND ART

As one of various kinds of razors, wet razors may be largely classified into razors for men and razors for women. A lot of studies have been conducted on the razors for men, but studies on the razors for women were comparatively rare. Thus, previously, women mostly used the razors for men.

However, it was not until the 2000s that a cartridge for women was released. Since the cartridge for women includes a lubricant such as soap, a separate auxiliary agent is not necessary during shaving. Also, due to the lubricant, it is possible to enhance soft feeling during shaving. However, because women's hair is softer than men's, it is relatively difficult to shave women's hair. Further, since women should shave various body parts such as armpits, arms and legs when compared to men, shaving may not be performed properly depending on the degree of contact with skin.

For example, in the case of parts such as arms and legs which are relatively smooth, shaving can be done properly. However, in the case of curved parts such as armpits, shaving may not be done properly because the degree of contact with skin is relatively low.

Further, because the body hair within those curved parts is relatively long, shaving may not be done properly when compared to short hair.

### DISCLOSURE

### Technical Problem

An object of the present invention is to provide a razor cartridge capable of reliably performing shaving regardless of the length or thickness of hair by firstly cutting with a single blade (i.e., a first blade) the hair aligned by a comb guard, and further cutting with multiple blades (i.e., second blades) the firstly cut hair, and a razor comprising the same.

Another object of the present invention is to provide a razor cartridge capable of preventing strong irritation or wounds to the skin of a person who is shaving as well as guaranteeing smooth hair-cutting by providing a lubricant during shaving, and a razor comprising the same.

### Technical Solution

According to an aspect of the present invention, there is provided a razor cartridge comprising: a frame forming an exterior; a comb guard protruding from a front end of the frame to align hair during shaving; a first blade which is coupled to a first slot formed at the front end of the frame and arranged adjacent to a rear portion of the comb guard to cut the hair aligned by the comb guard; and at least one second blade which is coupled to a second slot formed at a rear end of the cartridge frame to further cut the hair cut by the first blade. With this configuration, it is possible to reliably perform shaving regardless of the length or thickness of hair by firstly cutting the hair aligned by a comb guard by using a single blade, i.e., a first blade, and further cutting the firstly cut hair by using multiple blades, i.e., second blades.

The razor cartridge may further comprise a blade unit. The blade unit may comprise a cartridge frame accommodating the first blade and the second blade, and the comb guard may be provided at a front end of the cartridge frame.

In one embodiment, an upper portion of the first blade may be inclined to be bent toward the comb guard, and an upper end of the first blade may be provided at a position corresponding to an upper end of the comb guard.

In one embodiment, the at least one second blade may include multiple blades, and the second slot, the number of which corresponds to the number of the second blades, may be formed in the cartridge frame.

In one embodiment, protrusion guards having a height corresponding to a position of an upper end of the second blade may be formed in the cartridge frame to be located before and behind the second blade.

In one embodiment, the comb guard may include a plurality of comb members which are arranged regularly along a width direction of the cartridge frame, and a leading end portion of each of the comb members may be rounded.

In one embodiment, the razor cartridge may further comprise a lubricity providing portion which is coupled to the cartridge frame to be located between the first blade and the second blade, and provides lubricity to skin.

According to another aspect of the present invention, there is provided a razor comprising a razor cartridge including a cartridge frame, and at least one blade which is coupled to the cartridge frame to cut hair; and a soap frame which is detachably coupled to the cartridge frame to surround at least a portion of the cartridge frame, and provides a lubricant to the hair during shaving. With this configuration, it is possible to reliably perform shaving regardless of the length or thickness of hair by firstly cutting the hair, and further cutting the firstly cut hair by using blades, and also prevent strong irritation or wounds to the skin of a person who is shaving as well as smoothly cutting the hair by providing a lubricant during shaving.

In one embodiment, the blade may include a first blade which is coupled to a first slot formed at a front end of the cartridge frame to cut the hair; and at least one second blade which is coupled to a second slot formed at a rear end of the cartridge frame to further cut the hair cut by the first blade.

In one embodiment, a comb guard for collecting the hair before cutting the hair by the blade may be provided at the front end of the cartridge frame corresponding to the front side of the blade.

In one embodiment, the soap frame may include a lubricant receiving portion which provides the received lubricant depending on contact with the skin or pressing by the skin during shaving, and the hair may be collected in the soap frame during shaving.

In one embodiment, the soap frame may include a lubricant receiving portion which provides the received lubricant depending on contact with the skin or pressing by the skin during shaving. Further, the soap frame may include a comb guard which collects the hair during shaving and an auxiliary blade which firstly cuts the hair aligned by the comb guard.

### Advantageous Effects

According to embodiments of the present invention, it is possible to reliably perform shaving regardless of the length or thickness of hair by firstly cutting with a single blade (i.e., a first blade) the hair aligned by a comb guard, and further cutting with multiple blade (i.e., second blades) the firstly cut hair.

Also, according to embodiments of the present invention, it is possible to prevent strong irritation or wounds to the skin of a person who is shaving as well as guaranteeing smooth hair-cutting by providing a lubricant during shaving.

### DESCRIPTION OF DRAWINGS

FIG. 1 is an exploded perspective view of a razor cartridge according to an embodiment of the present invention.

FIG. 2 is an exploded perspective view of the razor cartridge shown in FIG. 1.

FIG. 3 is a plan view of the razor cartridge shown in FIG. 2.

FIG. 4 is a vertical cross-sectional view taken along line IV-IV of FIG. 3.

FIG. 5 is an exploded perspective view of a razor cartridge according to another embodiment of the present invention.

FIG. 6 is a perspective view of the razor cartridge according to the present invention.

### MODE FOR INVENTION

Hereinafter, configurations and applications of embodiments of the present invention will be described in detail with reference to the accompanying drawings. The following description is one of several aspects of the present invention as claimed, and forms a part of the detailed description of the present invention.

However, in the description of the present invention, a detailed description of well-known functions and configurations will be omitted in order to clarify the subject matter of the present invention.

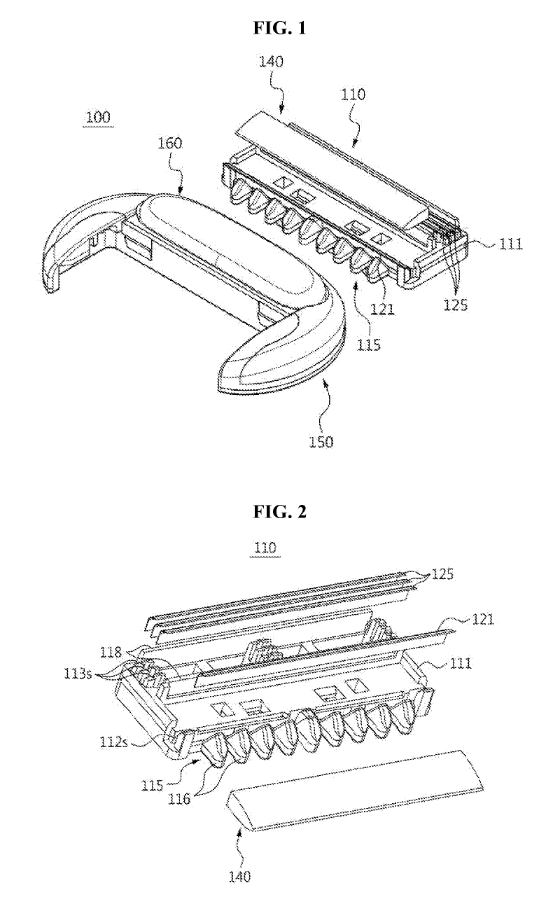

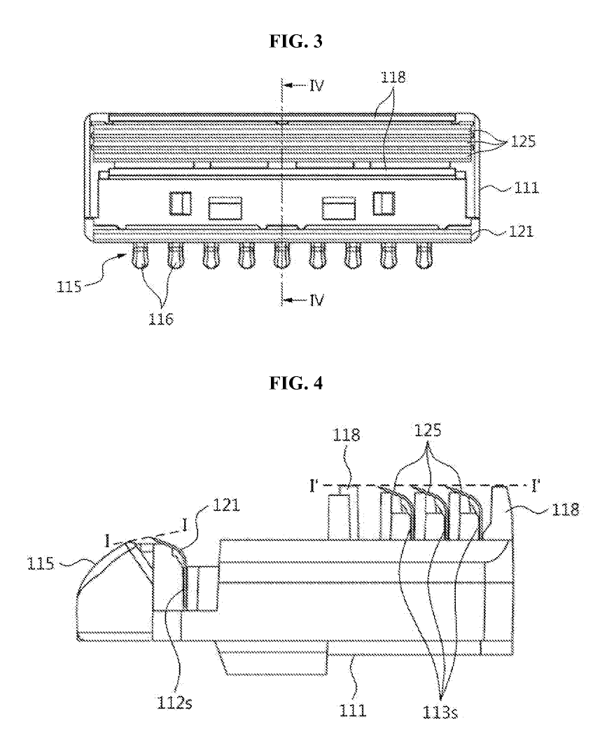

FIG. 1 is an exploded perspective view of a razor cartridge according to an embodiment of the present invention. FIG. 2 is an exploded perspective view of the razor cartridge shown in FIG. 1. FIG. 3 is a plan view of the razor cartridge shown in FIG. 2. FIG. 4 is a vertical cross-sectional view taken along line IV-IV of FIG. 3.

Referring to FIG. 1, a razor cartridge 100 according to an embodiment of the present invention may include a blade unit 110 having blades 121 and 125 for cutting hair in multiple stages, and a soap frame 150 to which the blade unit 110 is detachably coupled and which provides softness to a person who is shaving by proving a lubricant during shaving.

The blade unit 110 of the present embodiment may include, as shown in detail in FIGS. 2 to 4, a cartridge frame 111, a first blade 121 which is coupled to the front end of the cartridge frame 111 to firstly cut the hair, and a plurality of second blades 125 which are coupled to the rear end of the cartridge frame 111 to further cut the hair cut by the first blade 121. That is, the frame of the razor cartridge according to the present invention includes the soap frame 150 and the cartridge frame 111.

The cartridge frame 111 forming a basic frame of the blade unit 110 includes slots 112s and 113s to which the first blade 121 and the second blades 125 are coupled. The cartridge frame 111 further includes guards 115 and 118 to determine the degree of protrusion of the blades 121 and 125 such that the cutting using the blades 121 and 125 can be reliably achieved while maintaining safe contact with the skin.

The slots 112s and 113s include a first slot 112s to which the first blade 121 is coupled, and second slots 113s to which the second blades 125 are coupled.

Referring to FIG. 4, the first slot 112s has a lower portion which is formed in a slot shape and to which a lower portion of the first blade 121 is inserted and coupled. Further, the first slot 112s has an upper portion, one sidewall of which is formed in a shape corresponding to the inclined shape of an upper portion of the first blade 121 to support the first blade 121. Thus, it is possible to prevent the shape of the first blade 121 from changing.

Similarly, each of the second slots 113s has a lower portion which is formed in a slot shape as shown in FIG. 4. One sidewall of each of the second slots 113s is formed to support an upper inclined portion of each of the second blades 125. Thus, it is possible to firmly maintain the state of the second blades 125.

Meanwhile, a comb guard 115 is provided at the front end of the cartridge frame 111, i.e., in front of the first blade 121, as shown in FIG. 2. By providing the comb guard 115, it is possible to not only collect and align the hair, but also determine the degree of protrusion of the first blade 121.

The comb guard 115 of the present embodiment includes a plurality of comb members 116 which are arranged regularly along a width direction of the cartridge frame 111. By collecting the hair between the comb members 116 during shaving, it is possible to firstly cut the collected hair by the first blade 121, thereby improving the cutting efficiency of the hair.

Since each of the comb members 116 is in direct contact with the skin during shaving, a leading end portion thereof is rounded. Thus, it is possible to prevent irritation or wounds to the skin. As shown in FIG. 4, the upper end of the comb guard 115 is provided at the position corresponding to the upper end of the first blade 121. That is, the comb guard 115 has a curved shape such that the height of the comb guard 115 gradually increases toward the rear end. The upper end of the first blade 121 protrudes to correspond to the curvature of the curved surface of the comb guard 115. Thus, the cutting of the hair using the first blade 121 can be achieved smoothly.

In addition, as shown in FIG. 4, an imaginary line (line I-I) connecting the upper end of the comb guard 115 to the upper end of the first blade 121 becomes a first blade contact surface. In this case, by determining the position of the upper end of the first blade 121 so as to correspond to the curvature of the comb guard 115, the comb guard 115 collects relatively long hair when moving in contact with the skin during shaving. Accordingly, the first cutting of long hair can be reliably achieved.

Meanwhile, protrusion guards 118 are provided before and behind the second slots 113s, to which the second blades 125 are coupled, to adjust the degree of contact between the second blades 125 and the skin by determining the degree of protrusion of the second blades 125. Referring to FIG. 4, the protrusion guards 118 of the present embodiment are formed to protrude from the cartridge frame 111 to have a height corresponding to the positions of the upper ends of the second blades 125. Accordingly, when the firstly cut hair is further cut by the second blades 125, it is possible to appropriately maintain the degree of contact between the second blades 125 and the skin. Thus, by cutting the firstly cut hair again, it is possible to improve the reliability of shaving.

In addition, an imaginary line (line I′-I′) connecting the upper ends of the protrusion guards 118 located before and behind the second slots 113s forms a second blade contact surface. Thus, the hair can be further cut by the second blades 125 exposed above the contact surface. In this case, since the positions of the upper ends of the second blades 125 are made to correspond to the positions of the upper ends of the protrusion guards 118, the second blades 125 do not excessively protrude toward the skin. Thus, it is possible to prevent irritation or wounds to the skin.

Meanwhile, the blade unit 110 according to the embodiment of the present invention may further include a lubricity providing portion 140 which provides lubricity to the firstly cut hair during shaving such that the firstly cut hair can be further cut more smoothly. The lubricity providing portion 140 of the present embodiment is provided in the form of a lubrication band as shown in FIGS. 1 and 2. The lubricity providing portion 140 may be coupled to the upper surface of the cartridge frame 111 between the first slot 112s and the second slots 113s.

With this configuration, after cutting a long portion of the hair by the first blade 121, before the hair is further cut by the second blades 125, a lubricative material is applied and secured on the skin by the lubricity providing portion 140, so that the cutting by the second blades 125 can be more efficiently achieved.

As described above, the blade unit 110 of the present embodiment is configured such that after the hair is firstly cut by the first blade 121, the firstly cut hair is further cut by the second blades 125 of multiple blades, thereby enhancing the reliability of shaving.

In this case, since the hair is aligned by the comb guard 115, the efficiency of cutting the hair by the blades 121 and 125 can be increased. Further, since the comb guard 115 and the protrusion guards 118 adjust the degree of protrusion of the blades 121 and 125 to the skin during the cutting of the hair, it is possible to prevent irritation or wounds to the skin. Meanwhile, the blade unit 110 can be detachably coupled to the soap frame 150 as shown in FIG. 1. Since the soap frame 150 provides a lubricant such as lather during shaving, it is possible to improve the cutting efficiency of the hair during shaving, and provide soft feeling to a person who is shaving.

The soap frame 150 of the present embodiment is formed in a ‘⊂’ shape as shown in FIG. 1 to surround both side portions and a rear end portion of the cartridge frame 111. In the soap frame 150, soap 160 with cleaning and lubricating action is provided to provide a lubricant such as lather to the skin when the soap 160 is brought into contact with (or pressed to) the skin during shaving.

Thus, according to the embodiment of the present invention, a lubricant is provided during shaving by a detachable coupling structure of the blade unit 110 and the soap frame 150, so that the shaving can be smoothly achieved. In addition, since the shaving can be performed in multiple stages rather than one stage, there is an advantage of improving the reliability of shaving.

Next, a razor according to another embodiment of the present invention will be described. A description of parts having substantially the same configuration as the razor of the above-described embodiment will be omitted.

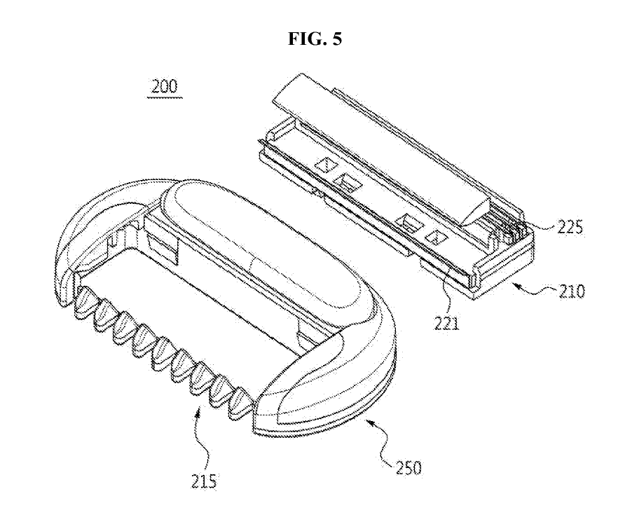

FIG. 5 is an exploded perspective view of a razor cartridge according to another embodiment of the present invention.

As shown in FIG. 5, a razor cartridge 200 according to another embodiment of the present invention also includes a blade unit 210 and a soap frame 250 to which the blade unit 210 is detachably coupled. The razor cartridge 200 has a difference in the position of a comb guard 215 from the razor cartridge 100 (see FIG. 1) of the above-described embodiment.

The above-described embodiment has a structure in which the comb guard 115 (see FIG. 1) is provided in the front end portion of the cartridge frame 111, whereas the present embodiment has a structure in which the comb guard 215 is provided in the soap frame 250.

That is, the soap frame 250 has a hollow rectangular shape as a whole, and the comb guard 215 is located in a portion corresponding to the front side of the razor cartridge 210.

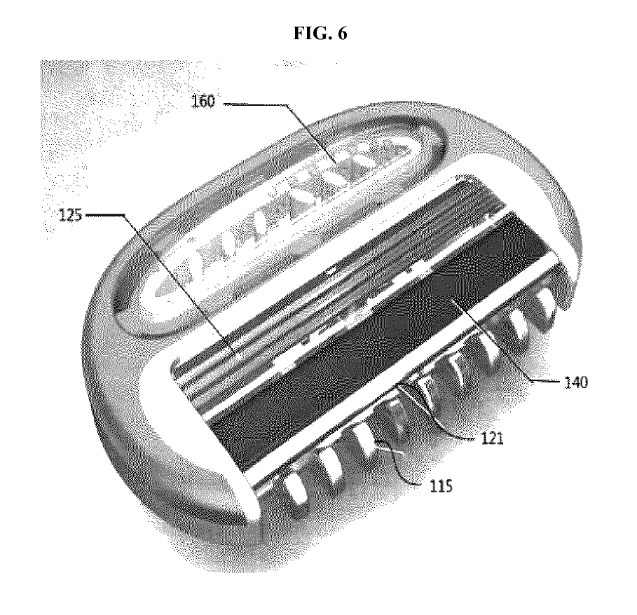

Thus, since the blade unit 210 is combined with the soap frame 250 as shown in FIG. 6, the razor cartridge 200 may have substantially the same structure as the razor cartridge 100 (see FIG. 1) of the above-described embodiment. Therefore, after the hair is aligned by the comb guard 215, the shaving can be carried out reliably by a first blade 221 and second blades 225.

Meanwhile, although not shown, an auxiliary blade corresponding to the first blade may be provided in the soap frame, not the razor cartridge. That is, the soap frame may be manufactured such that the first blade is provided behind the comb guard provided in the soap frame, and accordingly, only the second blades may be provided in the razor cartridge. Also in this case, a combination of the blade unit and the soap frame may have substantially the same configuration as the razor cartridges 100 and 200 of the above-described embodiments. Thus, the shaving can be performed reliably.

Although the embodiments of the present invention have been disclosed for illustrative purposes, those skilled in the art will appreciate that various modifications, additions and substitutions are possible, without departing from the scope and spirit of the invention as disclosed in the accompanying claims.

* Descriptions of Reference Numerals *

| | |
|---|---|
| 100: razor cartridge | 110: blade unit |
| 111: cartridge frame | 115: comb guard |
| 121: first blade | 125: second blades |
| 140: lubricity providing portion | 150: soap frame |
| 160: soap | |

What is claimed is:

1. A razor cartridge comprising:
a frame forming an exterior of the razor cartridge;
a comb guard protruding from a front end of the frame to align hair during shaving;
a first blade which is coupled to a first slot formed at the front end of the frame and arranged adjacent to a rear portion of the comb guard to cut the hair aligned by the comb guard; and
at least one second blade which is coupled to a second slot formed at a rear end of the frame to further cut the hair cut by the first blade.

2. The razor cartridge of claim 1, further comprising a blade unit, wherein the blade unit comprises a cartridge frame accommodating the first blade and the second blade, and the comb guard provided at a front end of the cartridge frame.

3. The razor cartridge of claim 1, wherein an upper portion of the first blade is inclined to be bent toward the comb guard, and an upper end of the first blade is provided at a position corresponding to an upper end of the comb guard.

4. The razor cartridge of claim 1, wherein the at least one second blade includes multiple blades, and the second slot, the number of which corresponds to the number of the second blades, is formed in the frame.

5. The razor cartridge of claim 4, wherein protrusion guards having a height corresponding to a position of an upper end of the second blade are formed in the frame to be located before and behind the second blade.

6. The razor cartridge of claim 1, wherein the comb guard includes a plurality of comb members which are arranged regularly along a width direction of the cartridge frame, and a leading end portion of each of the comb members is rounded.

7. The razor cartridge of claim 1, further comprising a lubricity providing portion which is coupled to the frame to be located between the first blade and the second blade, and provides lubricity to skin.

8. The razor cartridge of claim 2, further comprising a soap frame which is detachably coupled to the cartridge frame to surround at least a portion of the cartridge frame, and includes a soap for cleaning and lubricating function during shaving.
